(19) United States
(12) Patent Application Publication
(10) Pub. No.: US 2012/0305333 A1
(43) Pub. Date: Dec. 6, 2012

(54) Grain Rescue Tube

(76) Inventor: Roger K. Coulthard, Stockton, IL (US)

(21) Appl. No.: 13/152,679

(22) Filed: Jun. 3, 2011

(51) Int. Cl. A62B 99/00

(52) U.S. Cl. 182/230

(57) ABSTRACT

A rescue tube assembly includes multiple panels at least one of which is generally inflexible and at least partially flat and planar. The panels may be joined together by slidable engagement of compatible lateral side edges of the panels to form a tubular construction. The sides may be inserted into grain or other collapsed material such as soil in a manner which encircles an item or entity trapped by the collapsed material. The adjacent panels are slidably engaged to form an at least partially encircling enclosure to enable material such as grain or soil to be removed from the tubular form thereby permitting access and rescue of the entrapped individual.

### BACKGROUND OF THE INVENTION

In a principal aspect the present invention relates to a tubular assembly comprised of multiple parts or panels which may be assembled to form an enclosure that at least partially encircles and protects a person or item entrapped in collapsed grain or soil or the like. The multiple panels may be joined by connecting their lateral sides by means of integral, compatible connection elements. For example, the panel lateral side edges may include slidably engagable tongue and groove elements. In various embodiments one or more generally inflexible panels may be assembled at a rescue site or disassembled for storage or transport.

A circumstance which occurs particularly in rural, grain farming areas involves potential entrapment of a person working in a grain silo or grain elevator by the stored grain. Location and rescue of such persons has been identified as a problem which occurs more commonly than someone might expect. Problems of a similar nature often arise with respect to excavations of trenches, ditches and the like. Thus, there has developed a need to enhance the opportunity to rescue individuals who become trapped by such circumstances.

Various methods have been proposed to facilitate rescue and avoid entrapment. By way of example, and not limitation, are the teachings set forth in U.S. Pat. No. 4,310,267 which discloses a “Safety Trench Box”. The box is designed to protect workman from cave-ins within an excavated area such as a trench. The box is comprised of a series of structural elements which are fastened together to provide a defined working area within a trench. Such devices however, do not lend themselves to rescue situations particularly of persons trapped, for example, in a grain elevator or silo.

Another proposal for rescue of a person who is entrapped in soil or other material is disclosed in U.S. Pat. No. 7,325,338 entitled “Engulfment Rescue Device and Method”. The disclosure of this patent depicts a vacuum excavation mechanism for removing the soil or other material which entraps the victim. A very large and cumbersome vehicle and assembly of machinery is typically required to effect such a rescue operation.

Yet another approach is depicted in U.S. Pat. No. 6,062,342 entitled “Rescue Device for a Confined Space and Method of Using Thereof”. This patent discloses a device which includes a sheet that may be flexed to encircle an individual or person trapped, for example, in a grain silo. The opposite ends of the sheet may be fastened by separate connectors and the grain material or other material surrounding the individual removed by scooping or otherwise removing the surrounding grain thereby achieving access to the individual for purposes of rescue.

Yet another similar approach is depicted in an article from the Journal of Agricultural Systems, Technology and Education dated June, 2007, entitled Evaluation of Plastic Grain Engulfment Rescue Device, pages 727-741 incorporated herewith by reference.

Despite the various rescue means disclosed, there has remained the need for an improved method and means for effecting rescue of persons entrapped due to circumstances of the type described.

### SUMMARY OF THE INVENTION

Briefly the present invention comprises a rescue assembly that includes a plurality of panels which are at least in part generally inflexible and that may be interlocked to form a tube or a partial tube form. Multiple panels may thus be engaged and fitted around a trapped individual in order to at least partially encircle the individual by the connected panels which in combination form a protective barrier. The material within the formed enclosure may be removed and the person or individual rescued or extracted from the enclosure. The assembly may also be used by rescue personnel as a protective barrier when engaged in a rescue operation.

As an aspect of the invention, at least one panel is generally inflexible and includes a top side, a bottom side and opposed lateral sides connecting the top side and bottom side. The lateral sides of the panel are constructed to engage and the engagement mechanism is integrally incorporated in the lateral sides of the panel, for example, a tongue and groove connection assembly. In this manner a single panel may be positioned within the soil or grain or other material by forcing it downwardly into the material. An edge of a second panel may then be slidably connected to an edge of the first panel and driven into the material to further provide an encircling enclosure about the trapped individual. By utilizing multiple connectable panels wherein at least one of the panels is generally inflexible, care can be exercised during assembly of the protective barrier to avoid injuring the individual that is being rescued while at the same time assuring that separate panels can be appropriately connected to facilitate the assembly of the protective enclosure.

As another aspect of the invention, the panels may be comprised of two or more unitary panel sections which are joined together along a seam so that multiple similar panels, in combination, will display a geometric cross section configuration when assembled.

A further aspect of the invention is the use of at least one generally inflexible panel which acts as a starting point or anchor in the formation of the enclosure or rescue tube. Multiple inflexible panels may thus be assembled or an inflexible panel may be combined with panels that are at least partially flexible and joined to the generally inflexible panel. Some leeway is contemplated with respect to the flexibility of the panels in order to enable use of various materials in the formation of a multi panel enclosure or partial enclosure.

As another aspect of the invention, the panels and their various sections enable formation of multiple shapes of a rescue tube and provide the capability to vary the size of a formed rescue tube. That is, two or more panels can be assembled to provide variously sized rescue tube cross sections depending upon the number of panels that are utilized to construct the assembly. Consequently, use of one or two or more connected panel sections enable the design of various configurations of a rescue tube.

As another aspect of the invention, a tongue and groove type connection feature enables panels to be assembled in series or one after the other at a rescue site thereby providing an effective way to assemble a rescue tube without the use of special separate fasteners that must be engaged to connect or join the panels. Thus, the panels include an integral engagement feature comprised of compatible side edge connection elements which enable assembly of a rescue tube from multiple panels in an order which facilitates a desired shape or formation of the rescue tube.

A further aspect of the invention is associated with the design of panels having a generally rectangular configuration and/or parallel lateral sides. As a consequence the panels are reversible. That is, they may be assembled with either the top side or bottom side being insertable downwardly into material, e.g. grain. Also since panels may be comprised of two or more flat planar sections joined to form an angle with respect to one another, the formed rescue tube can be construed to fit around immovable objects in the collapsed material.

These and other objects, aspects and features of the invention will be set forth in the detailed description which follows.

### BRIEF DESCRIPTION OF THE DRAWING

In the detailed description which follows reference will be made to the drawing comprised of the following figures:

FIG. 1 is an isometric view of an embodiment of the rescue tube of the invention;

FIG. 2 is a top plan view of the embodiment of FIG. 1;

FIG. 3 is a side elevation of the embodiment of FIG. 1;

FIG. 4 is a partial isometric view of a connection or joinder mechanism of first and second adjacent panels used to create a rescue tube assembly;

FIG. 5 is a cross sectional view taken along the line 5-5 in FIG. 4;

FIG. 6 is a partial isometric view of the lower end of the panel assembly of FIG. 4;

FIG. 7 is an isometric view of an alternative construction of an embodiment of the invention;

FIG. 8 is a top plan view of a further alternative embodiment of the invention;

FIG. 9 is a isometric view of the embodiment of FIG. 8;

FIG. 10 is a top plan view of yet another configuration and combination of panels that form a rescue tube assembly; and

FIG. 11 is a cross sectional view of another combination of panels forming a rescue tube in a silo.

### DESCRIPTION OF EMBODIMENTS OF THE INVENTION

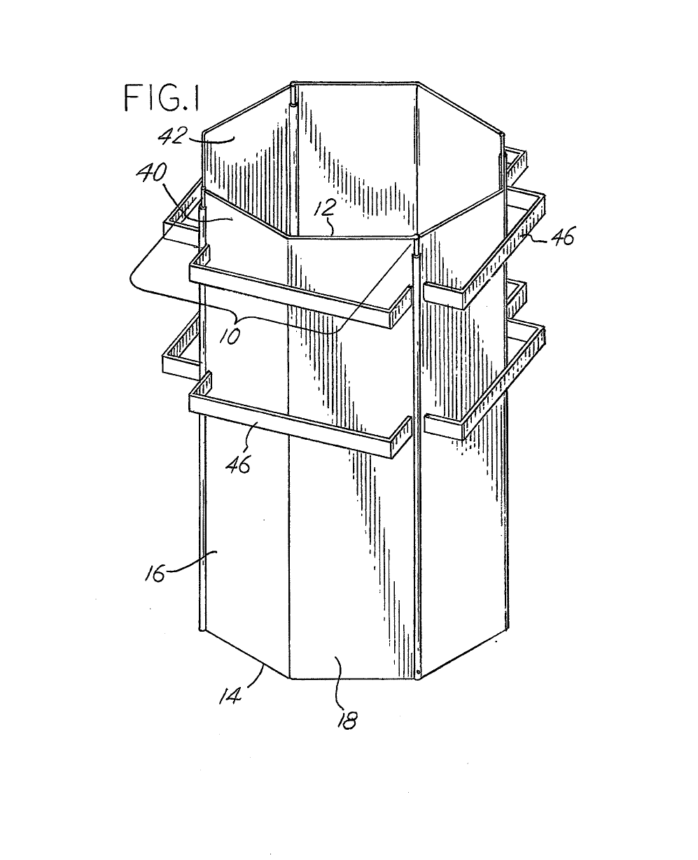

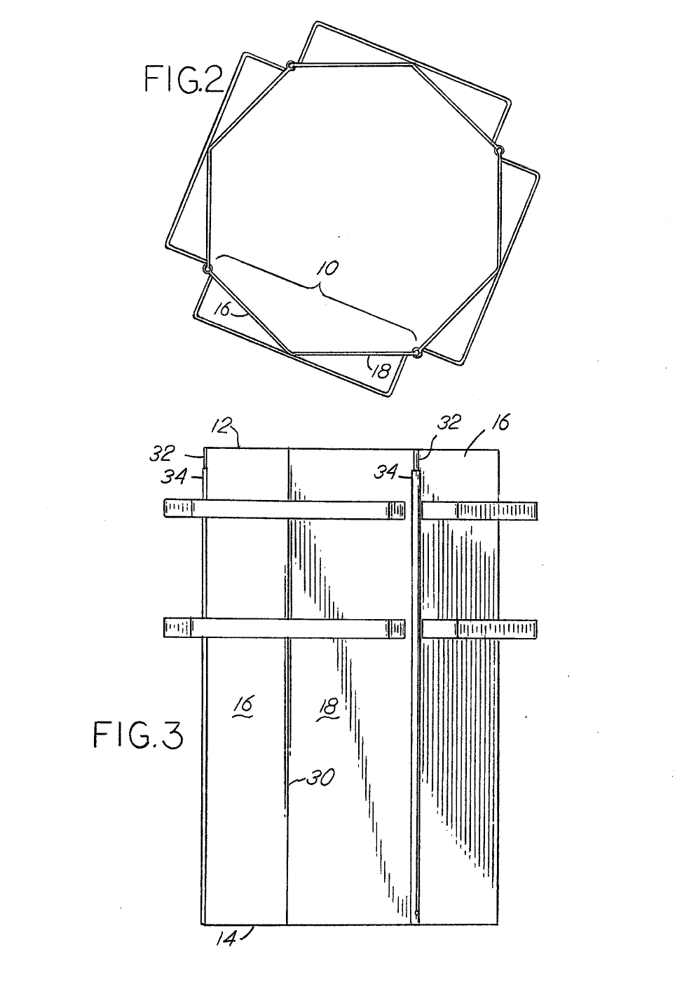

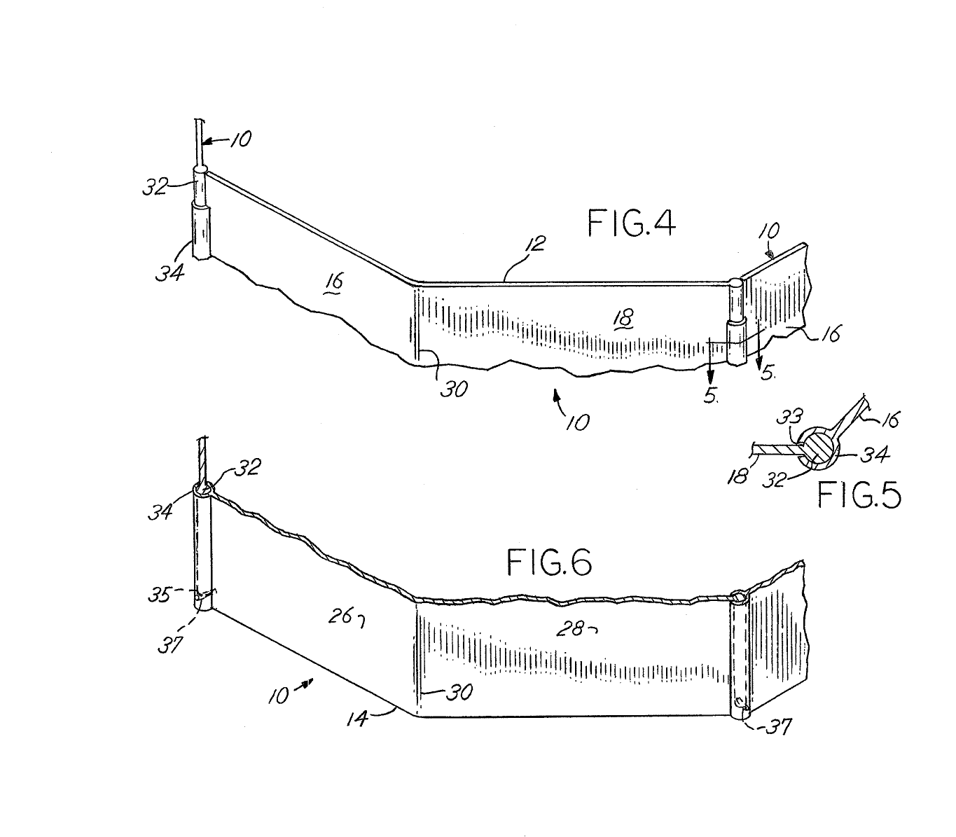

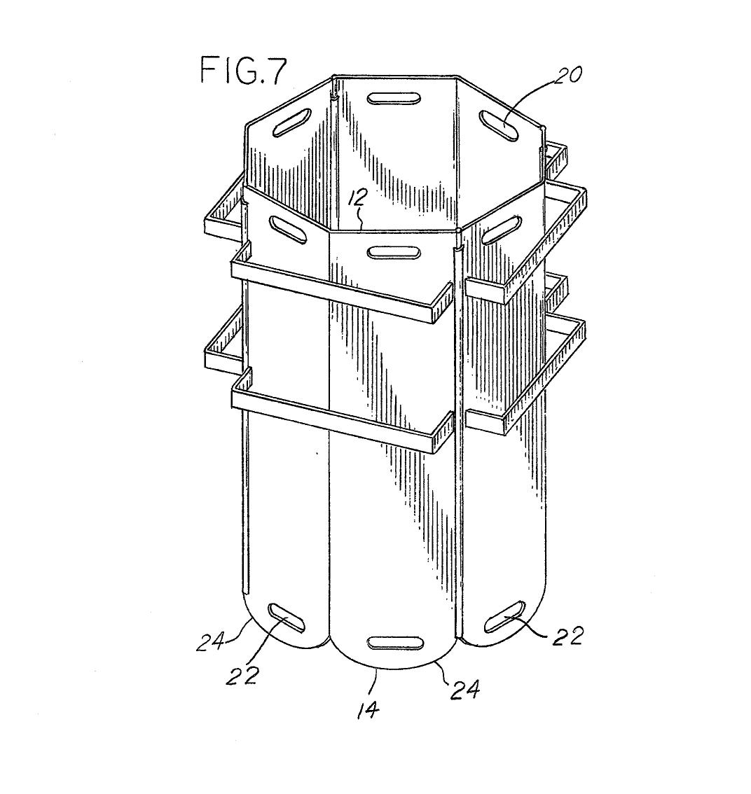

The figures depict the construction, shape and configuration of various typical panels 10. In FIG. 1 panel 10 includes a top side 12 and an opposed or opposite bottom side 14. Panels may be designed to be reversible whereby the top side may be reversed in terms of the assembly of the panels as will be evident based on the following description and text.

A typical panel 10 includes a first lateral side 16 and an opposed or opposite lateral side 18. Typically the first and second lateral sides 16 and 18 are parallel, straight sides. However, this is not a limiting feature of the invention. The first and second lateral sides 16, 18 may, for example, be at an angle with respect to one another. For example, the first and second lateral sides 16 and 18 may comprise the equal sides of a truncated, isosceles triangle. However, the lateral sides 16, 18 may form an angle with respect to one another that is skewed. That is, the sides 16, 18 may converge or diverge at distinct angles with respect to a median vertical panel axis.

The top side 12 and bottom side 14 are typically straight sides in order to facilitate storage and use in the field. However, either the top side 12 and the bottom side 14 may have various feature shapes and configurations. For example, the top side 12 may include an adjacent hand hold opening 20. The bottom side 14 may also include hand hold openings 22. The bottom side 14, which is typically flat and planar, may be angled outwardly or inwardly in whole or part to facilitate use and placement within soil or grain. The bottom side 14 may be shaped to include an arcuate section 24 or other shaped section that will facilitate utility.

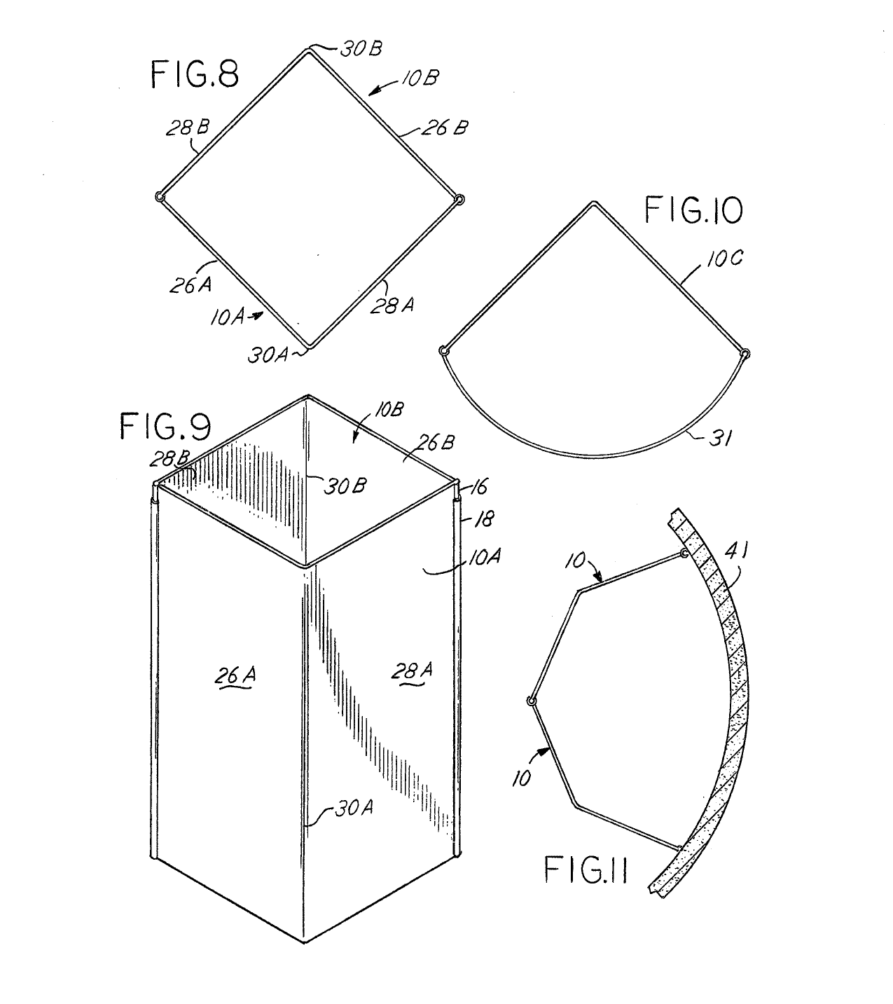

Typically panel 10 may be comprised of at least first and second generally flat, planar panel sections 26 and 28 which are joined along a seam 30. The sections 26 and 28 enable the use of as few as two panels 10 to form an enclosure upon the joinder of two such panels as shown in FIGS. 8 and 9. For example, two panels 10A, 10B in FIGS. 8 and 9 may have sections 26A,28A and 26B, 28B joined at right angles along a seam 30A, 30B which in combination enable the formation of a square cross section tubular enclosure. However, multiple panels having more than two panel sections may be utilized.

Further, a single panel such as panel 10C in FIG. 10 which is generally inflexible and maintains a fixed shape can be combined with a flexible panel 31 to provide an encircling enclosure.

Typically the panel sections such as sections 26 and 28 and which are joined along a seam 30 form an angle one with the other. The angle generally will be an obtuse angle or in certain circumstances a right angle. Typically the sections 26, 28 form at least a right angle at their juncture or seam 30 and typically the panel sections 26, 28 extend from the top side 12 to the bottom side of the panel 10. Of course, a panel 10 may comprise a single, flat, planar member for use in combination with other panels of a desired configuration.

An aspect of the invention comprises a connection means which enables the panels such as panels, 10A, 10B, to be slidably engaged or otherwise joined by compatible, integral side edge elements. The connection mechanism in the embodiment depicted is a tongue and groove arrangement. That is, one of the lateral sides, for example, first lateral side 16 comprises a tongue element. The second lateral side 18 comprises a groove element. The tongue and groove arrangement enables panels 10A, 10B to be assembled seriatim at a rescue site around a person trapped within grain or soil material as well as around obstructions. That is, a single panel 10A may first be inserted into the grain or material that collapsed to entrap a victim. The second panel 10B may then be joined to the first panel 10A by vertically slidably moving the second panel 10B downwardly to thereby engage a tongue element 32 with a groove element 34, of the first panel 10A which is embedded in grain.

In the embodiment shown, the groove 34 is depicted as having at least a partially circular cross section which is compatible with the tongue member or element 32 which has the form of a rod having at least a partially circular cross section. The tongue and groove elements 32, 34 are thus compatible with each other and integral with the lateral sides 16, 18. They are arranged along the opposed lateral sides 16 and 18 of the panel 10. The grooves 34 are open along a longitudinal slit 33 so that the wall of panel 10 may be fit through the slit 33. Groove 34 typically has a greater width than the thickness of the panel 10 adjacent the rod or tongue 32. This enables some “play” or room for pivotal movement of the adjacent connected panels 10.

The grooves 34 as well as the rod or tongue members 32 may be continuous or discontinuous. Thus, the groove 32 or rod 34 may be discontinuous with openings or sections thereof which are open. The bottom 35 of the rod 32 may be configured so that it will easily slide into a groove 34. Thus, the bottom 35 of the rod 32 may be angled to facilitate movement through the groove 34 as panels 10 are joined together. The bottom 35 of the groove 34 may also include a stop 37 to limit the movement of a panel 10 and more particularly the rod or tongue member 32 downwardly.

The distance between the top side 12 and bottom side 14 of each of the panels may be the same. However, this is not a limiting aspect of the invention and a single large panel 10 may, for example, be designed to receive and be cooperative with multiple other stacked panels having a distinct lesser different height or distance between the top and bottom sides 12 and 14.

The tongue 32 and groove 34 connection is a desired feature inasmuch as individual panels may be individually or separately positioned within the soil to surround a person trapped in soil or grain. Alternative designs for tongue and groove connections may be provided such as a ball and socket joint, a T-shaped tongue and compatible groove or other compatible connection schemes incorporated integrally in the lateral sides 16, 18.

Typically the panels 10 will include an outside surface 40 and an inside surface 42. Typically the inside surface 42 is a smooth surface but it may include hand holds, flexible loops or brackets to facilitate the rescue of an individual. The outside surface 40 may typically include brackets or reinforcing braces 46 which enable and facilitate placement of the panels 10, driving of the panels 10 into the grain or soil, and stacking of the panels 10 for transport. Thus, the panels 10 are connectable to form a tubular type or partial tubular type of enclosure with an open top, open bottom and side faces with brackets, hand holds, access panels, etc.

The panels are fabricated from a generally inflexible material such as aluminum or steel or PVC plastic materials or the like. Typically the panels 10 are generally inflexible in order to enhance the opportunity to form a adequately rigid enclosure. However, some panels may be flexible in order, for example, to attach generally flexible elements 31 such as depicted in FIG. 10 to a generally inflexible element or panel 10 and thereby provide the opportunity to effectively design a rescue tube at a rescue site that is suitable for the conditions such as the type of material in which the victim is embedded or located. Typically at least one generally inflexible panel 10 is appropriate when assembling a tube construction.

The methodology for the use and recovery of a person that has been entrapped in a flowable material typically involves the following steps. When rescuing an individual from a silo or grain elevator, a first step is to terminate the ingress of further grain that would engulf the individual or victim. Then it is necessary to locate the individual. Often only the head or hand or some other body part will be visible to help locate the victim or victim that is entrapped. Thermal imaging and/or draining a portion of the grain from the bin or area of entrapment may help locate a victim that has been submerged within the material. The individual typically, however, must be seen or at least a portion exposed in order to facilitate placement of the panels 10 comprising the tube enclosure which is to be constructed.

Once the victim has been located, the separate panels 10 are assembled and fitted around or at least partially around the individual. Each panel is pushed into the grain by a distance that is easily feasible and which may be as little as six to twelve inches. The tube sections are then formed and once a ring is formed around the individual the grain can be moved out from the enclosure and the enclosure may be incrementally moved downwardly and around the individual to facilitate rescue. In other words, the formation of the enclosure can be undertaken step wise and ultimately fitted around the entire individual as grain is removed from the enclosure.

Another benefit of the construction of the present invention is that the side wall of a silo or elevator can serve as a barrier or part of the rescue enclosure. That is, the panels 10 can be assembled and fitted against the side wall as thereby serving as an enclosure which includes a section of the silo wall such as depicted in FIG. 11. As another feature the panels 10 may be assembled to protect a rescue worker in the silo as that worker engages in the rescue operation.

The panels though generally inflexible are of relatively thin construction of steel, aluminum or plastic and sized so that they may individually easily fitted into the enclosure (silo, etc.) and then pushed into the grain manually or by a mechanical vibratory device. It is noted that if all of the panel sections are similar construction, then they can be easily stored and stacked with one next to the other.

While there has been set forth embodiments of the various component parts as well as the assembly of a rescue tube and a method of use thereof, and whereas various embodiments of the invention have been disclosed and described, the invention is nonetheless not limited thereto. Rather the invention is limited only by the following claims and equivalents. Further, the various terms used in the description of the invention is not limiting. Prepositions, adjectives, adverbs and the like should be construed in the broadest sense.

1. A rescue tube device comprising:
a plurality of panels, each panel having first and second lateral sides, a top side and a bottom side, the first said lateral side including a first integral connecting member, the second said lateral side including a second integral connecting member compatible for connecting engagement with said first member, at least one of said panels being generally inflexible and comprised of at least one flat planar panel section whereby adjacent panels are connectable to form a generally at least partially tubular enclosure by slidable engagement of the first connecting member with the second connecting member an adjacent panel.

2. The device of claim 1 wherein the generally inflexible panel is comprised of at least two panel sections forming an angle with each other with an apex at the juncture thereof along a seam and extending between the top side and bottom side of the panel.

3. The device of claim 2 wherein the sections of said generally inflexible panel form an included obtuse angle.

4. The device of claim 1 comprised of a plurality of generally inflexible panels.

5. The device of claim 1 wherein said generally inflexible panel includes an inside face and an outside face and further including a reinforcing bracket member affixed to said outside face.

6. The device of claim 1 wherein said first member comprises a tubular section along said first lateral side.

7. The device of claim 6 wherein said second member comprises a generally circular cross section rod shaped member.

8. The device of claim 1 wherein said first member has a generally at least partially circular cross sectional shape.

9. The device of claim 1 wherein said first member extends along the length of said first lateral side.

10. The device of claim 1 wherein said first member extends partially along said second lateral side.

11. The device of claim 1 wherein the lateral sides are straight and parallel.

12. The device of claim 2 wherein the lateral sides of each panel are parallel and straight.

13. The device of claim 1 wherein the lateral sides of each panel are parallel and straight, and wherein the second member comprises a partially circular cross section rod and the first member comprises a partially circular cross sectional shaped groove and a lateral side slit.

14. A rescue tube device comprising:
a plurality of a generally inflexible, connectable panels, each panel including a top side, a bottom side, a first generally straight lateral side, a second generally straight lateral side and at least one of said panels comprised of at least first and second generally flat planar panel sections jointed along a seam and forming an angle with respect to each other,
said first sides including a first edge portion and said second sides including second edge portion compatibly engagable with the first edge portion to connect adjacent panels,
said panels connectable to at least partially form a tube having an outside surface and which is open along the top side and bottom side.

15. The device of claim 14 wherein at least one panel is comprised of at least two panel sections joined along a seam generally parallel to one of the lateral sides.

16. The device of claim 14 including at least one support bracket on the outside surface of at least one panel.

17. The device of claim 14 wherein each panel is substantially identical.

18. The device of claim 14 wherein each panel comprises a unitary structure.

19. The device of claim 14 wherein the distance between the top side and bottom side of each panel is substantially the same.

20. The device of claim 14 wherein the lateral sides of each panel are parallel.

21. A rescue tube device comprising:
a plurality of a generally inflexible, connectable panels, each panel including a top side, a bottom side, a first generally straight lateral side, a second generally straight lateral side and at least one of said panels comprised of at least an arcuate section,
said first sides including a first edge portion and said second sides including second edge portion compatibly engagable with the first edge portion to connect adjacent panels,
said panels connectable to at least partially form a tube having an outside surface and which is open along the top side and bottom side.
